(19) United States
(12) Patent Application Publication
(10) Pub. No.: US 2016/0151126 A1
(43) Pub. Date: Jun. 2, 2016

(54) Universal Retrofit Dental Abutment

(71) Applicant: ADAPTALL MANUFACTURING INC., Mississauga (CA)

(72) Inventor: Leo NIKE, Mississauga (CA)

(21) Appl. No.: 15/015,413

(22) Filed: Feb. 4, 2016

Related U.S. Application Data
(63) Continuation-in-part of application No. 14/082,384, filed on Nov. 18, 2013.

(51) Int. Cl. A61C 8/00

(52) U.S. Cl. CPC A61C 8/0065; A61C 8/0039; A61C 8/0074

(57) ABSTRACT

A dental abutment for retrofit use to allow for repair of different types of existing root form implants after traumatic events, reduces or eliminates the need for further surgery. The abutment comprises a threaded spindle having an integrated taper, a plurality of segments secured around the axis of the spindle, and a tapered nut threaded on a distal end of the spindle. The threaded engagement of the tapered nut radially displaces the segments against the root form, fixing the abutment thereto.

### RELATED APPLICATIONS

This application is a continuation-in-part of U.S. patent application Ser. No. 14/082,384, filed Nov. 18, 2013.

### FIELD OF THE INVENTION

This invention relates to dental implants and, in particular, a dental implant which allows for repair of an existing root form implant after a traumatic event which reduces or eliminates the need for further surgery.

### BACKGROUND OF THE INVENTION

Dental implant systems are well known in the art for replacing one or more dead or missing teeth. For example, common dental implant systems include a base which is integrated into one of the upper and lower jaw, and an abutment which attaches to the base. The base is often called a root form, as it looks and behaves similar to the root or roots of a tooth or teeth. Once the abutment is attached to the root form, a dental prosthesis is bonded to the abutment using known techniques. The dental prosthesis may take the form of a replacement tooth, a bridge and the like.

Installing a dental implant into a patient's mouth is often a multi-step process. For example, typical approaches to implantation may include preparing a site for implantation, surgically inserting a root form into the jaw, allowing a sufficient amount of time for the root form to osseointegrate (i.e. fuse with the surrounding bone), connecting an abutment to the root form, and finally attaching a replacement prosthesis to the abutment. A multi-step process involving a multi-part dental implant system is the preferred approach for many dentists and dental surgeons, as it allows for the proper integration of the root form within the surrounding bone (usually taking between 2 to 6 months) without the root form being affected by a patient's chewing during the osseointregration step. When suitably integrated into the jaw, the root form may provide a solid anchor in which to attach the abutment and subsequent dental prosthesis may be connected.

Typical dental implant technology often employs the use of threads, both in the male end female configurations, to connect the abutment to the root form implanted within the jaw. For example, the dental implant may utilize corresponding threads on both the root form and the abutment to allow the abutment to be screwed into the root form. Once connected, the abutment may have an attachment connector or end for bonding a dental prosthesis to the abutment. The dental prosthesis may be glued, cemented or otherwise connected to the abutment.

While typical dental implants allow for the connection of a dental prosthesis to a root form, the inventors have appreciated that the diameter and pitch of different threaded abutments vary from one manufacturer to another. However, thread identification tools which could distinguish between manufacturers does not exist making the removal of broken threads impossible.

Furthermore, where a patient with an installed dental implant is involved in a trauma, such as a motor vehicle accident or a sports-related injury, a portion of the abutment may break off or shear. The threads of the abutment and/or root form may also become damaged by other means. If this occurs, a dentist or dental surgeon may have difficulty in removing the abutment from the root form and finding a replacement abutment.

The inventors have also appreciated that, in some cases, damage to the threads of the root form and/or the abutment may make removal or replacement of the damaged abutment impossible. In other cases, the dentist and/or dental surgeon may be unable to identify or distinguish the threads of the root form in order to locate a replacement abutment even with known thread identification tools. In this situation, the dentist or dental surgeon may be forced to remove the osseointegrated root form and begin the multi-step implantation process over again by installing a new root form. If a new root form is required, a patient will require adequate time (often months) to recover from the removal of the previous root form before the new root form can be surgically installed. Even more time will then be required for the new root form to become osseointegrated and for a new abutment and dental prosthetic to be put in place. Accordingly, replacing an installed dental implant with a new root form is both time-consuming and uncomfortable for the patient.

The root form is generally embedded in the jaw with drilling techniques applied by the implantologist or the dental surgeon. After an adequate period of time, the root form becomes sufficiently integrated with the going through the process of osseointegration to allow for connection to the abutment. The abutment is then connected to the root form through the use of threads in one form or another to achieve a stable connection before the mounting of the dental prosthesis.

### SUMMARY OF THE INVENTION

Accordingly, it is an object of this invention to provide an improved dental implant system.

In one embodiment, the present invention provides an improved implant that will not require the removal of an osseointegrated implant or root form in the event that there is a catastrophic failure due to an unforeseen traumatic event.

In another embodiment, the invention provides an improved implant that will not require the removal of an osseointegrated implant in the event that there is a catastrophic failure due to an unforeseen traumatic event notwithstanding that the diameter or pitch of the threads of the abutment are unknown and cannot be determined.

In yet another embodiment, the invention provides a new and improved abutment which may be used in a dental implant system which allows for the replacement of a dental prosthesis without removal of an osseointegrated root form.

More preferably, invention provides a new and improved abutment which has eliminated the need to identify the diameter and pitch of the threads in an already embedded root form, when a dental prosthesis needs to be replaced.

In a preferred construction, the dental abutment includes a threaded spindle having an axially extending portion which is elongated along a longitudinal axis portion, a sleeve having a plurality of radially displaceable segments circumferentially affixed to or secured about the axially extending portion of the spindle, and a tapered nut threaded on the distal end of the spindle and selectively engagable with the sleeve.

Accordingly, in one aspect the present invention resides in the combination of an abutment and a root form osseointegrated into a patient's jaw, the root form including an internal bone, the abutment being sized for insertion at least partially within said internal bore and including, an elongated spindle extending from a proximal end to a distal end, the spindle having a longitudinal axis portion with a threaded portion spaced towards the distal end, a sleeve positioned on the axis portion of the spindle, the sleeve including a plurality of radially displaceable segments, and a nut having a tapered end, and threadedly engaging the threaded portion, the spindle being rotatable in said bore relative to the nut to selectively move the tapered end into engagement with the sleeve and bias the segments radially outwardly into engaging contact with side portions of said internal bore.

In another aspect the present invention resides in an abutment for use in combination with a root form having internal bore sized to receive the abutment in position therein, the abutment including, a longitudinally elongated spindle extending from a proximal end to distal end, the spindle including a longitudinal axis portion having a threaded distal end, and a distally tapering portion spaced towards the proximal end, a nut having a proximally tapering end threadedly engaging the threaded distal end, an expandable sleeve comprising at least one radially displaceable segment being secured to the spindle and interposed between the tapering portion and the nut, the spindle being rotatable relative to the nut to selectively move the tapering portion and tapering end relatively and into engagement with the sleeve to move the segments radially outwardly and into engagement against sides of said internal bore.

In yet a further aspect, the present invention resides in the combination of a root form having a drilled bore in which internal threads are at least partially removed and a dental abutment for mounting a prosthesis, said abutment comprising a threaded spindle having an integrated taper and a longitudinal axially extending portion having a distal threadable end, a sleeve circumferentially affixed to the axially extending portion of the spindle, said sleeve having a first one and a second and opposite end, two sets of spaced apart elongated slots, a first said set of slots extending from said first end of said sleeve to about a middle of said sleeve, and the second set of said slots extending from the second end of said sleeve inwardly to about the middle of said sleeve, said first set of slots being offset from said second set of slots, and a tapered nut threaded on the distal end of the spindle, whereby said dental abutment is insertable into said root form bore and is releasably securable to said root form by rotating said threaded spindle to releasably press fit said sleeve against said root form.

Other features of the invention will be apparent to those skilled in the art from the following detailed description of the embodiments thereof.

### BRIEF DESCRIPTION OF THE DRAWINGS

Reference may now be had to the following detailed description taken together with the accompanying drawings in which:

FIG. 1 shows an exploded view of a dental implant system showing a root form and denial abutment of a first embodiment the present invention.

FIG. 2 shows a perspective view of displaceable segments used in securing an abutment in accordance with a further embodiment;

FIG. 3 shows a perspective view of the sleeve shown in FIG. 1;

FIG. 4 shows a perspective view of the threaded spindle;

FIG. 5 shows the assembled abutment of FIG. 1 in isolation following its insertion and expansion in a root form bore;

FIG. 6 shows the tapered nut;

FIG. 7 shows the assembled segments of FIG. 2.

### DETAILED DESCRIPTION OF THE PREFERRED EMBODIMENTS

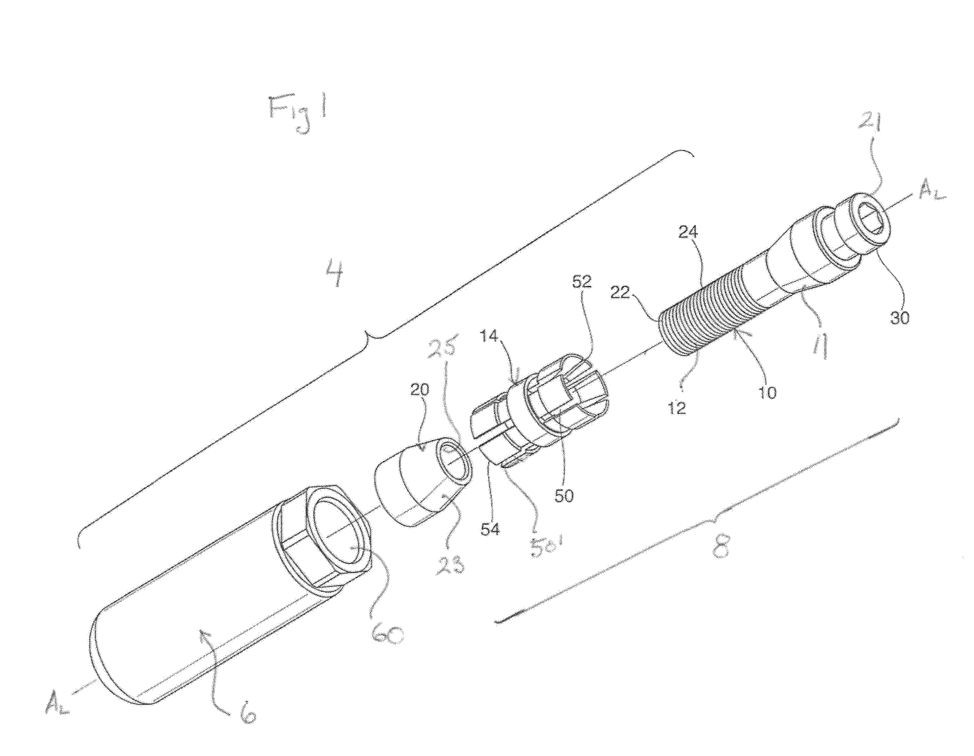

Reference may be had to FIG. 1 which illustrates a dental implant system 4 in accordance with a preferred embodiment. As will be described, the system 4 includes a root form 6, which is osseointegrated into a patient's jawbone, and preferably as part of an earlier implant procedure, and a dental abutment 8 for use in mounting a replacement dental prosthesis (not shown), as for example, where the root form 6 has previously been subject to trauma and implant failure. In this regard, the dental abutment 8 may advantageously by used not only in new implant placement procedures, but also with a variety of different types and/or models of existing implanted root forms, including those made by third party manufacturers.

As illustrated in the drawings, in one embodiment the abutment 8 has a diameter selected to allow for its positioning within an axially extending implant bore 60 (FIG. 1). The abutment 8 includes a threaded spindle 10, a sleeve 14, and a tapered nut 20. The spindle 10 extends axially in the direction of the longitudinal axis A_{L}-A_{L} from a proximal end 21 to a distal end 22. The spindle 10 includes a driver portion 30 axially positioned at the proximal end 21, an integrated taper 11 spaced towards the proximal end 21, and a longitudinal axially extending portion 12 which includes a distal threaded end portion 24 extending to the distal end 22.

As shown best in FIG. 1, the threaded nut 20 includes an inwardly tapering proximal-most end 23 and internal threads 25 which are selected to threadedly engage the distal threaded portion 24 of the spindle 10.

The sleeve 14 is circumferentially affixed to the axially extending portion 12 of the spindle 10, interposed between the tapered end 23 of the tapered nut 20 when threaded on the distal end 22 of the spindle 10, and the integrated taper 11.

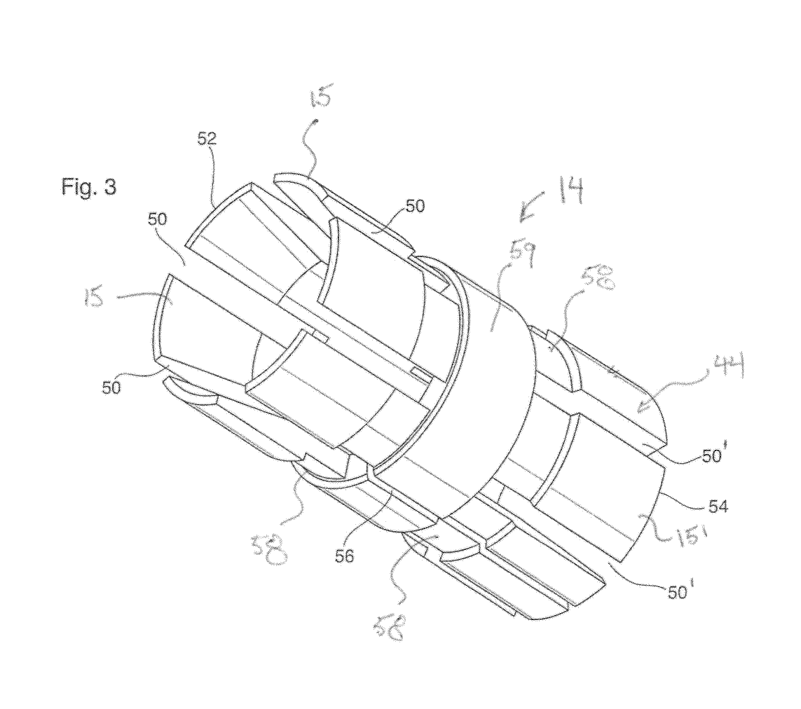

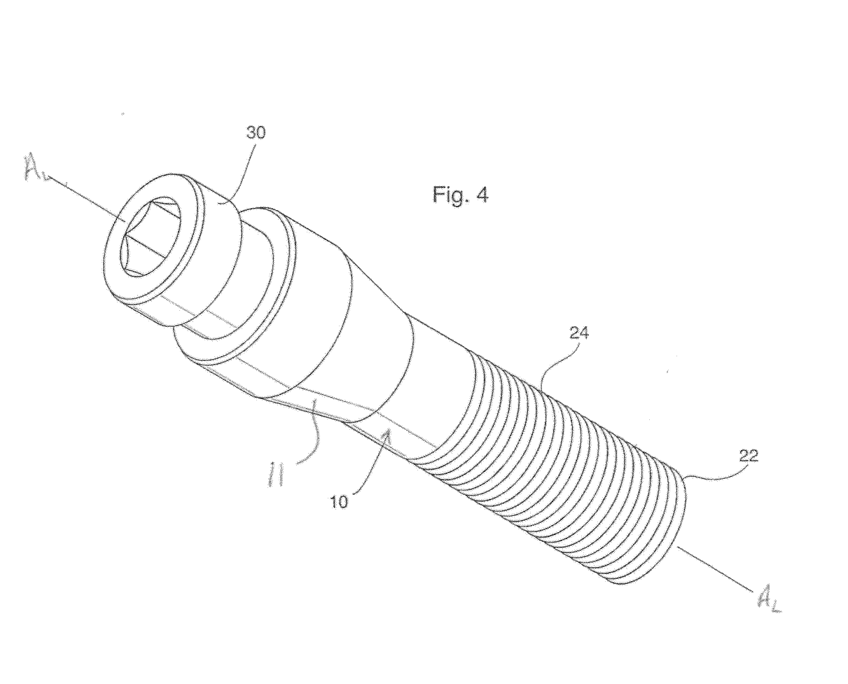

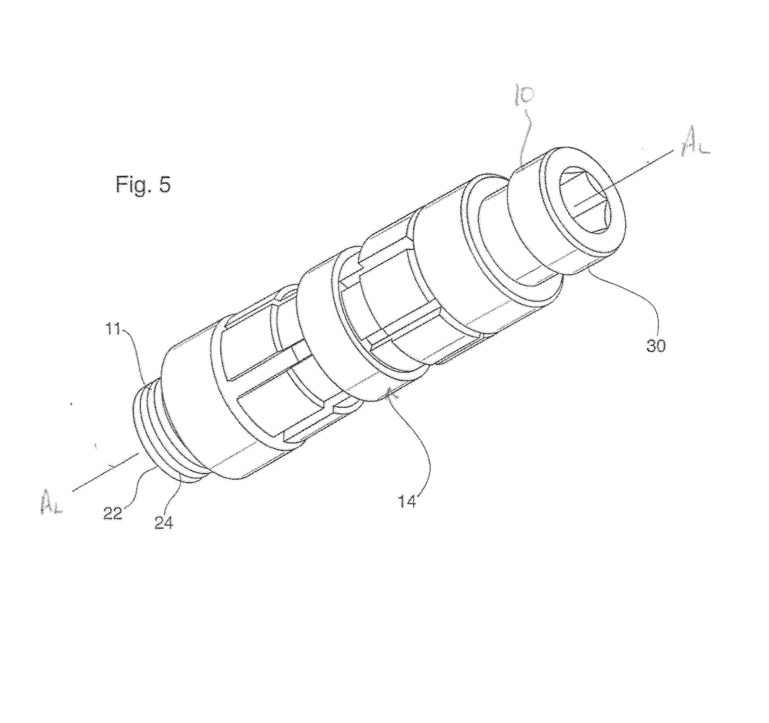

The sleeve 14, as shown in FIG. 3, has a single piece radial design which includes a cylindrical body 44 which extends axially from a first end 52 to a second end 54. Two sets of radially spaced elongated slots 50,50′, which are positioned alternatively, extend from end 52 and end 54 to no more than one-half the length of the sleeve 14. Optionally a continuous side-slot 56 may be provided running the entire axial length of the sleeve 14. FIG. 3 shows best each radially adjacent pair of slots 50,50 and 50′,50′ as respectively defining a sleeve segment 15,15″ therebetween. FIG. 3 further shows each segment 15,15′ as including a respective thinned or bevelled portion 58 spaced towards a mid-portion 59 of the sleeve body 44. As will be described, once the sleeve 14 is positioned within the bore 60, the segments 15,15″ are selectively moveable to radially outwardly displaced positions to engage the root form 6 and assist in securing the abutment 8 in position within an internal axial bore 60 of the root form 6.

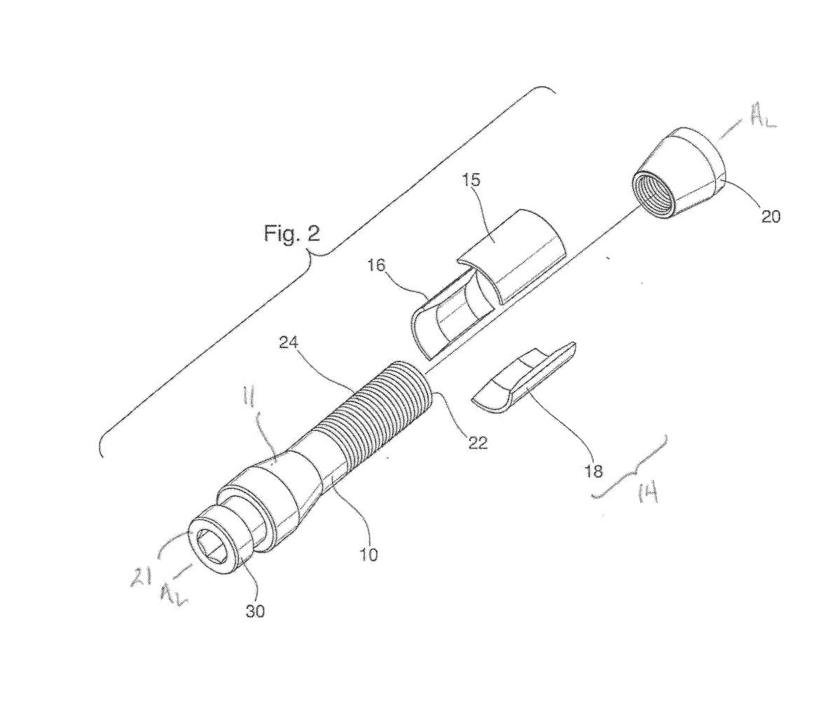

A second embodiment of the sleeve 14 is shown in FIG. 2 in which like numerals are used to identify like components. FIG. 2 shows the sleeve 14 as having a plurality and preferably three frangible segments 15, 16 and 18 circumferentially affixed to the threaded portion 24 of the spindle 10, and a tapered nut 20 threaded on the distal end 22 of the spindle.

While FIG. 2 shows three segments 15, 16 and 18, the invention is not so restricted as any number of segments may be used which encompass the threaded portion 24 of the spindle 10.

In the construction shown, the sleeve 14 or the segments 15, 16 and 18 may be secured to the threaded portion 24 of the spindle 10 by using a dental grade epoxy. Alternately, the segments 15,16,18 may be held by an expansion spring which encompasses the segments 15, 16 and 18 in a groove (not shown).

In order to insert the abutment 8, the female threads of the osseointegrated root form 6 are first progressively drilled from the root form bore 60, as in the standard dental procedure done today to remove an implant. However, the root form 6 is drilled only enough to remove the existing threads, regardless of the pitch and standard of the manufacturer. The root form bore 60 is drilled to a predetermined internal diameter that would allow and facilitate the insertion of the abutment 8.

Alternatively, it is also possible to insert the abutment 8 without drilling out the female threads of the osseointegrated root form bore 60.

The abutment 8 is first assembled by securing the sleeve 14 or segments 15, 16 and 18 to the spindle 10. Preferably a sleeve 14 of the type shown in FIG. 3 is slid axially over the longitudinal axially extending portion 12 and threaded distal end portion 24, and against the integrated taper 11. The tapered nut 20 is then threaded on to distal end 22 of the spindle 10, whereby the sleeve 14 is mechanically retained between the nut 20 and taper 11. The distal-most end 22 of the assembled abutment 8, including the nut 20, sleeve 14 and longitudinal axially extending portion 12 is then inserted and seated into the drilled bore 60.

Once the abutment 8 is seated, the driver portion 30 is used to rotate the spindle 10 about its longitudinal axis and relative to the nut 20. By its threaded engagement, the rotation of the spindle portion 10 moves the nut 20 axially along the threaded portion 24 and towards the proximal end 21.

As the nut 20 moves, the tapers 21,23 are moved relatively towards each other and inward into each respective end 52,54 of the sleeve 14. The inward movement of the tapers 11,23 biases the segments 15′ radially outwardly against the sides of the bore 60, effecting their radial movement tangential to the longitudinal axis A_{L}-A_{L} of the spindle 10, and generating enough force to holds the abutment 8 in place in the root form 6.

The abutment 8 may be inserted in to the bore 60 by means of surgical tweezers and is aligned in the root form 6 by means of the spindle 10 interacting with the root form 6.

After installation, the implantologist or dentist can move place the prosthesis (not shown) on the end 21 of the abutment 8 as in the prior art.

The driver portion 30 of the spindle 10 can be operated with any suitable means such as a socket head set screw arrangement which uses a hexagonal key to turn the spindle 10. Other examples of suitable devices would include a wrench and a small head or a small socket to achieve the desired locking. A clear advantage is that the torque requirements would be minimal.

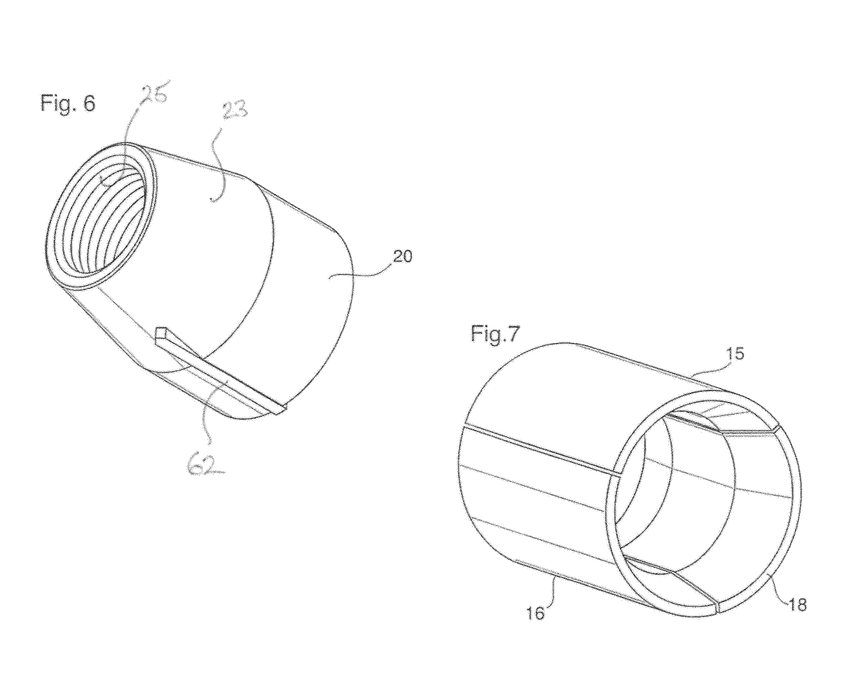

When the sleeve 14 used in the invention includes a longitudinal slot 56, a longitudinal extending key 62 may be provided on the threaded nut 20 (FIG. 6). The key 62 is provided on the tapered portion 23 to align with the slot 52, and to provide linear stability during actuation and rotation of the spindle 10 to effect the locking feature.

The continuous slot 52 is provided to give linear stability during the tightening phase and it allows also for easy radial expansion of the sleeve 14 with minimum force applied to the spindle 10 to achieve adequate lock up.

As the spindle 10 is rotated, the key 62 resists rotation by virtue of its engagement within the continuous slot 52 to effectively operate as one unit on a radial plane while remaining in function on a linear plane.

The abutment 8 may be formed of a suitable biocompatible material such as, for example, medical-grade titanium and the like.

Commercially available medical grade titanium is available in for separate grades which encompasses different levels of ductility and rigidity. These also offer very stable oxide surfaces which when subject to damage, demonstrate self-healing properties in the presence of air and water. Thus this stable oxide lends itself well to osseointegration.

A second suitable material is the class of cobalt-chromium-molybdenum based alloys. These alloys have good conventional machining properties useful for extreme geometries due to the presence of the cobalt and the chromium adds corrosion resistance and provide a good oxide surface. Strength is added by the presence of the molybdenum. Dental implants made from these alloys have demonstrated excellent biocompatibility. It should be noted that cast cobalt should be avoided because implants made of this material are the least ductile materials used in surgical dental implants and manufacturing techniques that incorporate a bending procedure after casting should be avoided.

A third suitable material is the group of iron-chromium-nickel alloys which include stainless steels and a group known as austenitic stainless. These alloys can be passiviated after machining to provide an oxide surface for osseointegration. If any allergenic potential is noted, these alloys should be avoided. These alloys should also not be used in concert with titanium, cobalt or zirconium and carbon based biomaterials because of their tendency for galvanic corrosion when combined.

Although this disclosure has described and illustrated certain preferred embodiments of the invention, it is also to be understood that the invention is not restricted to these particular embodiments rather, the invention includes all embodiments which are functional, or mechanical equivalents of the specific embodiments and features that have been described and illustrated herein. The scope of the claims should not be limited by the preferred embodiments set forth in the examples, but should be given the broadest interpretation consistent with the description as a whole.

It will be understood that although various features of the invention have been described with respect to one or another of the embodiments of the invention, the various features and embodiments of the invention may be combined or used its conjunction with other features and embodiments of the invention as described and illustrated herein.

We claim:

1. In combination, an abutment and a root form osseointegrated into a patient's jaw,
the root form including an internal bore,
the abutment being sized for insertion at least partially within said internal bore and including,
an elongated spindle extending from a proximal end to a distal end, the spindle having a longitudinal axis portion with a threaded portion spaced towards the distal end,
a sleeve positioned on the axis portion of the spindle, the sleeve including a plurality of radially displaceable segments, and
a nut having a tapered end and which threadedly engages the threaded portion,
the spindle being rotatable in said bore relative to the nut to selectively move the tapered end into engagement with the sleeve and bias the segments radially outwardly into engaging contact with side portions of said internal bore.

2. The combination as claimed in claim 1, wherein the sleeve comprises a generally cylindrical body extending longitudinally from a first end to a second end,
a first set of slots extending longitudinally from the first end to about a mid-portion of the body,
a second set of slots extending longitudinally from the second end to about the mid-portion of the body, and
wherein adjacent ones of said slots defining at least one said displaceable segment therebetween.

3. The combination as claimed in claim 2, wherein the sleeve segments further include a respective thinned portion spaced towards the mid-portion of the body.

4. The combination as claimed in claim 2, wherein the first set of slots is offset radially from the second set of slots.

5. The combination as claimed in claim 1, wherein said abutment comprises a retrofit abutment, and said root form bore comprises a drilled bore in which implant bore threads have been at least partially removed.

6. The combination as claimed in claim 1, wherein said spindle includes a distally tapering portion interposed between said threaded portion and said proximal end.

7. The combination as claimed in claim 1, wherein the spindle includes a driver portion disposed at said proximal end.

8. An abutment for use in combination with a root form having internal bore sized to receive the abutment in position therein,
the abutment including,
a longitudinally elongated spindle extending from a proximal end to distal end, the spindle including a longitudinal axis potion having a threaded distal end, and a distally tapering portion spaced towards the proximal end,
a nut having a proximally tapering end threadedly engaging the threaded distal end,
an expandable sleeve comprising at least one radially displaceable segment being secured to the spindle and interposed between the tapering portion and the nut.
the spindle being rotatable relative to the nut to selectively move the tapering portion and tapering end relatively and into engagement with the sleeve to move the segments radially outwardly and into engagement against sides of said internal bore.

9. The combination as claimed in claim 8, wherein said abutment comprises a retrofit abutment, and said root form bore comprises a drilled bore in which bore threads have been at least partially removed.

10. The combination as claimed in claim 9, wherein the sleeve comprises a generally cylindrical body extending longitudinally from a first end to a second end,
a first set of slots extending longitudinally from the first end to about a mid-portion of the body,
a second set of slots extending longitudinally from the second end to about the mid-portion of the body, and
wherein adjacent ones of said slots defining said at least one radially displaceable segment.

11. The combination as claimed in claim 10, wherein the first set of slots is offset radially from the second set of slots.

12. The combination as claimed in claim 10, wherein the at least one radially displaceable segments further include a respectable thinned portion spaced towards the mid-portion of the body.

13. In combination, a root form having a drilled bore in which internal threads are at least partially removed and a dental abutment for mounting a prosthesis, said abutment comprising
a threaded spindle having an integrated taper and a longitudinal axially extending portion having a distal threadable end,
a sleeve circumferentially affixed to the axially extending portion of the spindle,
said sleeve having a first end and a second and opposite end, two sets of spaced apart elongated slots, a first said set of slots extending from said first end of said sleeve to about a middle of said sleeve, and the second set of said slots extending from the second end of said sleeve inwardly to about the middle of said sleeve, said first set of slots being offset from said second set of slots, and
a tapered nut threaded on the distal end of the spindle, whereby said dental abutment is insertable into said root form bore and is releasably securable to said root form by rotating said threaded spindle to releasably press fit said sleeve against said root form.

14. The combination as claimed in claim 13 wherein said abutment is made from a material selected from the group consisting of titanium, a cobalt-chromium-molybdenum alloy and an iron-chromium-nickel alloy.

15. The combination as claimed in claim 13 wherein said threaded spindle has a driver portion for driving the integrated taper in an axial movement relative to and into the sleeve.

16. The combination of claim 13, wherein said root form is an osteointegrated root form implant which has been damaged by trauma.

17. The combination as claimed in claim 15, wherein said sleeve comprises an axially extending cylindrical body, said sets of slots each defining one or more radially displaceable sleeve segments.

18. The combination as claimed in claim 17, wherein the sleeve segments further include a respective thinned portion spaced towards the mid-portion of the body.

19. The combination as claimed in claim 1, wherein said sleeve comprises an axially extending cylindrical body, said body including a through-slot extending axially from a first sleeve end to a second other sleeve end.

20. The combination as claimed in claim 8, wherein said sleeve includes a through-slot extending axially from a first sleeve end to a second other sleeve end.
